(19) United States
(12) Patent Application Publication
(10) Pub. No.: US 2004/0232624 A1
(43) Pub. Date: Nov. 25, 2004

(54) Closed annular sealing material and method for manufacturing same

(76) Inventors: Hirokazu Hisano, Ako-shi (JP); Masayuki Aso, Yokohama-shi (JP)

Correspondence Address: Dianne Burkhard, W. L. Gore & Associates, Inc., 551 Paper Mill Road, P.O. Box 9206, Newark, DE, 19714-9206, US

(21) Appl. No.: 10/798,067

(22) Filed: Mar. 11, 2004

(30) Foreign Application Priority Data
Mar. 11, 2002 (JP) 2003-65191

(51) Int. Cl. F16J 15/46

(52) U.S. Cl. 277/500

(57) ABSTRACT

An object of the present invention is to reduce the workload at the installation site even when the sealing material is in the form of a band. The sealing material that achieves the aforementioned object is a closed annular sealing material, wherein the ends in the peripheral direction of one or a plurality of expanded porous polytetrafluoroethylene bands are joined to each other. The width (W) of the sealing material from the inner periphery to the outer periphery is greater than the thickness (t) of the outer peripheral surface thereof; and the angle of elevation of the annular portion of the sealing material in relation to the horizontal plane formed by the edge of the inner peripheral surface thereof is 0 to 45° or 0°.

### FIELD OF THE INVENTION

This invention relates to a closed annular sealing material that is especially useful as a seal for flanges on pipes or vessels (as well as tanks), manhole covers, and regions of other industrial devices that come into contact with each other.

### BACKGROUND OF THE INVENTION

Sealing materials made of polytetrafluoroethylene (PTFE), which is exceptionally corrosion-resistant, are extensively used in pharmaceuticals, foodstuffs, chemical engineering and other fields in regions where pipes that convey corrosive fluids are joined to each other.

Examples of applications include sealing materials comprising unexpanded polytetrafluoroethylene that has been manufactured by means of sintering (“sintered PTFE” hereunder). However, sintered PTFE is a hard material, and hence does not adhere (fit) well to the fine irregularities in piping joints (e.g., on flanges) and fails to deliver adequate sealing performance unless the tightening torque has been sufficiently increased. A phenomenon known as interfacial leakage tends to occur as a result, with fluids escaping via the interface between the joint and the sealing material. Glass-lined joints, in particular, have a relatively high degree of unevenness and are low in strength, which makes it difficult to increase the tightening torque, and has accordingly led to a strong demand for PTFE sealing materials that adhere to joints exceptionally well.

Examples of sealing materials made of PTFE that have been drawing attention include those made of expanded porous polytetrafluoroethylene (“ePTFE” hereunder) that allow the adhesion with the joint to be increased with a relatively low amount of tightening torque. ePTFE sealing materials are softer than those made of sintered PTFE, and can readily deform in the thickness direction of the material, thereby increasing the adhesion with the joint and providing exceptional sealability. An example thereof is the ePTFE sealing material disclosed in Japanese Laid-Open Utility Model Application (Jikkai) 3-89133, wherein an annular or other shape is punched from an ePTFE film laminate comprising ePTFE films that have been laminated together to form an assembly of a prescribed thickness. FIG. 33 is a schematic oblique perspective view used to illustrate a method for manufacturing the sealing material by means of punching. With the punching method, sealing materials are manufactured as a result of punching out annular articles 20 from a laminated sheet 10 comprising a plurality of ePTFE film layers. However, the punching method cannot be used to punch out sealing materials of a size greater than the sheet, and is therefore unable to produce large-diameter gaskets. The method is also uneconomical because the punched laminate 10 is otherwise unusable and must be discarded, regardless of whether a large amount of unused ePTFE remains.

FIG. 34 is a schematic oblique perspective view used to illustrate a further method for manufacturing annular ePTFE sealing materials. In this example, a cylindrical laminate 11 is manufactured by means of winding layers of ePTFE film around a mandrel 50, and the cylindrical laminate is cut in intervals that correspond to the thickness (P) of the sealing material to produce annular sealing materials. However, such manufacturing methods are similarly uneconomical because mandrels of various diameters need to be prepared in advance to accommodate the inside diameters of the joints.

On the other hand, sealing materials are also known to exist in the form of bands (e.g., rods and tapes) as well as annular shapes (e.g., Japanese Laid-Open Patent Application (Kokai) 54-145739, Japanese Laid-Open Utility Model Application (Jikkai) 60-75791, Japanese Laid-Open Patent Application (Kokai) 62-108464, and U.S. Pat. No. 5,964,465 (specification)). These sealing materials are manufactured by means of extruding the PTFE into molded rods or tapes, which are subsequently stretched uniaxially in the lengthwise direction. Such materials may alternatively be manufactured by laminating and sintering (i.e., bonding) biaxially stretched PTFE films and cutting the resulting articles into bands. Sealing materials that are in the form of bands are cut to a suitable length after having been aligned with the size of the joint (e.g., the flange), and are ultimately employed in a the shape of a ring by having both ends in the lengthwise direction overlap each other while the material is affixed to the sealing surface of the flange. These sealing materials may be used on joints of any configuration without any wastage, and provide an economical solution.

FIG. 35 is a schematic oblique perspective view illustrating a sealing material 30 in the form of a tape, which is disclosed in U.S. Pat. No. 5,964,465 (specification). The sealing material 30 comprises a laminated sheet slit to a prescribed width (Q) and formed from layers of biaxially stretched ePTFE film. One of the laminated surfaces is further laminated with an adhesive layer (not shown), and the surface of the adhesive layer is protected by a release sheet (not shown).

With band-shaped sealing materials, however, it is necessary not only to form closed rings in the location where the materials are to be installed, but also to prevent any leakage from occurring in the overlapping regions formed when one end is laid over the other, so highly skilled staff is needed to perform this work.

### BRIEF DESCRIPTION OF THE DRAWINGS

FIG. 1 is a schematic oblique perspective view depicting an example of the closed annular sealing material of this invention;

FIG. 2 is a schematic oblique perspective view of the tape used in the closed annular sealing material of FIG. 1;

FIG. 3 is a schematic oblique perspective view depicting the closed annular sealing material of FIG. 1 in a deformed state;

FIG. 4 is a schematic oblique perspective view depicting the closed annular sealing material of FIG. 1 in an installed state;

FIG. 5 is a schematic oblique perspective view of the flanges where the closed annular sealing material of FIG. 1 is attached;

FIG. 6 is a schematic oblique perspective view depicting another example of the closed annular sealing material of this invention;

FIG. 7 is a schematic oblique perspective view of the flanges where the closed annular sealing material of FIG. 6 is attached;

FIG. 8 is a schematic oblique perspective view depicting yet another example of the closed annular sealing material of this invention;

FIG. 9 is a cross-sectional view along line A-A′ in FIG. 8;

FIG. 10 is a schematic oblique perspective view depicting another example of the closed annular sealing material of this invention;

FIG. 11 is a schematic oblique perspective view depicting yet another example of the closed annular sealing material of this invention;

FIG. 12 is a schematic oblique perspective view depicting still another example of the closed annular sealing material of this invention;

FIG. 13 is a schematic oblique perspective view depicting an example of the method for manufacturing the thin ePTFE tape used in this invention;

FIG. 14 is a schematic oblique perspective view depicting another example of the method for manufacturing the thin ePTFE tape used in this invention;

FIG. 15 illustrates schematic oblique perspective views depicting the method for manufacturing the flat-board laminate and the method for manufacturing of the ePTFE tape used in this invention;

FIG. 16 is a schematic oblique perspective view depicting an example of the method for manufacturing the closed annular sealing material of this invention;

FIG. 17 is a schematic oblique perspective view depicting another example of the method for manufacturing the closed annular sealing material of this invention;

FIG. 18 is a schematic oblique perspective view depicting an example of the thick ePTFE tape used in this invention;

FIG. 19 is a schematic oblique perspective view depicting another example of the ePTFE tape used in this invention;

FIG. 20 is a schematic oblique perspective view depicting yet another example of the method for manufacturing the closed annular sealing material of this invention;

FIG. 21 is a schematic oblique perspective view depicting still another example of the method for manufacturing the closed annular sealing material of this invention;

FIG. 22 illustrates schematic plan views depicting the method for manufacturing the closed annular sealing material of this invention;

FIG. 23 illustrates schematic oblique perspective views depicting another example of the thin ePTFE tape used in this invention;

FIG. 24 illustrates schematic oblique perspective views depicting another example of the thick ePTFE tape used in this invention;

FIG. 25 illustrates schematic oblique perspective views depicting yet another example of the thick ePTFE tape used in this invention;

FIG. 26 is an enlarged schematic side view illustrating the tapering used in this invention;

FIG. 27 is a schematic oblique perspective view of the square support plate used in this invention;

FIG. 28 is a schematic oblique perspective view of the presser used in combination with the support plate of FIG. 27;

FIG. 29 is a schematic oblique perspective view of a sealing material obtained in the working examples;

FIG. 30 is a schematic oblique perspective view of the arcuate support plate used in this invention;

FIG. 31 is a schematic oblique perspective view of the presser used in combination with the support plate of FIG. 30;

FIG. 32 is a schematic oblique perspective view of another sealing material obtained in the working examples;

FIG. 33 is a schematic oblique perspective view depicting an example of the conventional closed annular sealing material;

FIG. 34 is a schematic oblique perspective view depicting an example of the conventional closed annular sealing material; and

FIG. 35 is a schematic oblique perspective view depicting an example of the conventional tape sealing material.

### DETAILED DESCRIPTION OF THE INVENTION

With the foregoing aspects in view, it is an object of this invention to provide a sealing material that enables the workload at the installation site to be reduced even when the sealing material is in the form of a band.

The main point of the closed annular sealing material of this invention that can achieve the aforesaid object is that the ends in the peripheral direction of one or a plurality of expanded porous polytetrafluoroethylene bands are joined to each other; the width (W) of the sealing material from the inner periphery to the outer periphery is greater than the thickness (t) of the outer peripheral surface thereof; and the angle of elevation of the annular portion of the sealing material in relation to the horizontal plane formed by the edge of the inner peripheral surface thereof is 0 to 45°. The main point of the closed annular sealing material of this invention may also be that the aforementioned angle of elevation is 0° C. According to this invention, the angle of elevation may be 0° even if the ratio (W/t) of the width (W) to the thickness (t) of the sealing material is 5 or more, and even if the ratio (x/W) of the diameter (x) of the inner periphery thereof to the width (W) of the sealing material is 15 or less (i.e., when the sealing material describes a substantially circular shape). Closed annular sealing materials having a 0° angle of elevation may have a rectangular shape, and the radius of the inscribed circle at the corner of the inner periphery is preferably 10 mm or less (and ideally 0 mm).

The aforementioned annular portion has a laminate structure comprising expanded porous polytetrafluoroethylene layers. The aforementioned expanded porous polytetrafluoroethylene layers may be laminated across the width (W) direction or the thickness (t) direction. When laminated across the width (W) direction, a non-porous polytetrafluoroethylene layer is preferably inserted between the laminated expanded porous polytetrafluoroethylene layers.

At least one edge in the peripheral direction of the aforementioned band is preferably tapered, and the tapered surface preferably comprises at least a part of the band joint. The ends of the aforementioned band may be joined to each other, e.g., by means of any of (1) to (3) below.

(1) Double-sided adhesive tape

(2) Adhesive

(3) Heat fusion or ultrasonic welding via at least one film selected from a group consisting of a tetrafluoroethylene-hexafluoropropylene copolymerized film and a tetrafluoroethylene-perfluoroalkylvinylether copolymerized film

An adhesive layer may be formed on either one of the annular flat surfaces orthogonal to the outer peripheral surface of the aforementioned closed annular sealing material.

Closed annular sealing materials having an angle of elevation of 0 to 45° may be manufactured as described hereunder. In other words, these materials may be manufactured as a result of bending, in the width (W) direction, an expanded porous polytetrafluoroethylene band (occasionally referred to hereunder as “thin band”) whose length in the thickness (t) direction of the resulting closed annular sealing material is less than the width (W) thereof (consequently, the length in the thickness (t) direction is equal to the thickness (t) of the sealing material to form a ring as a whole; pre-fixing the thin band to maintain the bent shape; and thermosetting the thin band; where the directions are defined based in a coordinate system comprising the width (W) direction, thickness (t) direction, and peripheral direction of the resulting closed annular sealing material (as similarly pertains to the description hereunder). The two ends in the peripheral direction of the aforementioned thin band may be joined to each other before, during, or after the thermosetting.

In addition, closed annular sealing materials having an angle of elevation of 0° may be manufactured as described hereunder. In other words, the materials may be manufactured as a result of bending, in the width (W) direction, one or a plurality of expanded porous polytetrafluoroethylene articles (e.g., bands or boards; in the description hereunder the aforementioned bands are occasionally referred to as “thick bands”, the aforementioned boards as “thick boards”, and these thick bands and thick boards collectively as “thick articles”) whose length in the thickness (t) direction of the resulting closed annular sealing material is equal to or greater than the width (W) thereof to form a ring as a whole; pre-fixing the thick articles to maintain the bent shape; thermosetting the thick articles; and slicing the resulting thermoset assembly to a prescribed thickness (t) (i.e., the thickness of the sealing material). The two ends in the peripheral direction of the aforementioned thick articles (or slices thereof) may be joined to each other before, during, or after the thermosetting, but preferably after slicing.

As has been described in the foregoing, the directions are occasionally defined in the present specification based on a coordinate system comprising the width (W) direction, thickness (t) direction, and peripheral direction of the sealing material (occasionally referred to hereunder simply as the “sealing material coordinate system”).

Moreover, within this specification, the term “ring” designates a “single full circle”, and is not limited to round shapes.

This invention is described in further detail below with reference being made as needed to the appended drawings.

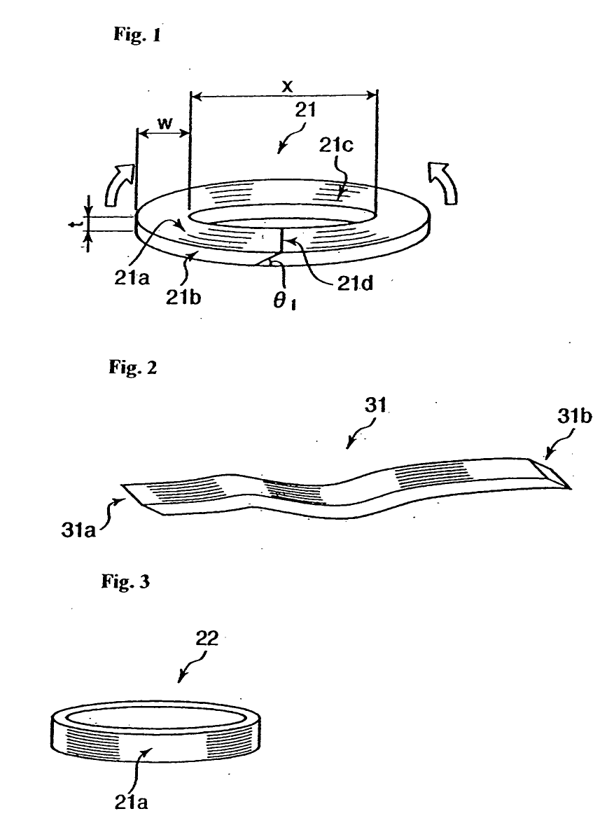

FIG. 1 is a schematic oblique perspective view depicting an example of a closed annular sealing material 21 of this invention, and FIG. 2 is a schematic oblique perspective view showing an instance where the aforementioned closed annular sealing material 21 has been spliced at a joint 21d. As is evident from FIG. 2, the closed annular sealing material 21 is formed from a band 31 made of expanded porous polytetrafluoroethylene (ePTFE), with ends 31a, 31b on the peripheral direction of the band 31 corresponding to the joint 21d.

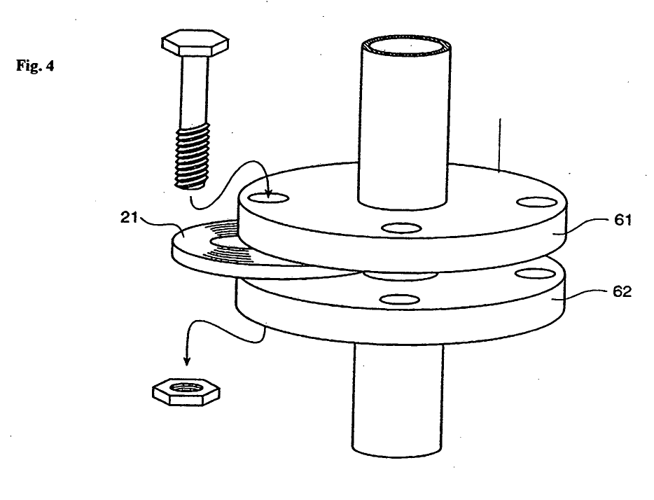

The closed annular sealing material 21 of this invention is of a substantially flat shape, with the width (W) of an annular flat surface 21a (i.e., the width (W) from the inner periphery to the outer periphery of the sealing material) being greater than the thickness (t) of an outer peripheral surface 21b (occasionally referred to hereunder as the “sealing material thickness”). It is common for the outer periphery of such substantially flat sealing materials, which have been formed as a result of closing the band-shaped materials into rings, to be subjected to greater tension than the inner periphery thereof, and hence to be more readily deformed in the direction of contraction (indicated by the arrows in FIG. 1). In other words, the annular flat surface 21a will rise up, and readily deform into a substantially vertical cylindrical article 22 whose outer peripheral surface has a large thickness (t), as is illustrated in FIG. 3. However, the closed annular sealing material 21 of this invention is endowed with a suitable degree of creasing, and the material can be set in a form that enables a substantially flat shape to be maintained without the material deforming into a substantially vertical cylindrical shape. In other words, the annular sealing material of this invention is characterized in being able to maintain a substantially flat shape even in the absence of a supporting member, in contrast to the aforementioned band-shaped sealing materials that are formed into rings while affixed to a flange. The ability of the material to maintain a substantially flat shape is thought to derive from the characteristics of the ePTFE that constitutes the band. A porous structure comprising the ePTFE nodes and fibrils described hereunder can remain flexible and strong merely as a result of absorbing the stresses created by means of the elongation of the outer periphery and compression of the inner periphery when the band is formed into a ring. Layers 21c that are formed from ePTFE film are laminated in the width (W) direction of the annular flat surface 21a in the aforementioned sealing material 21.

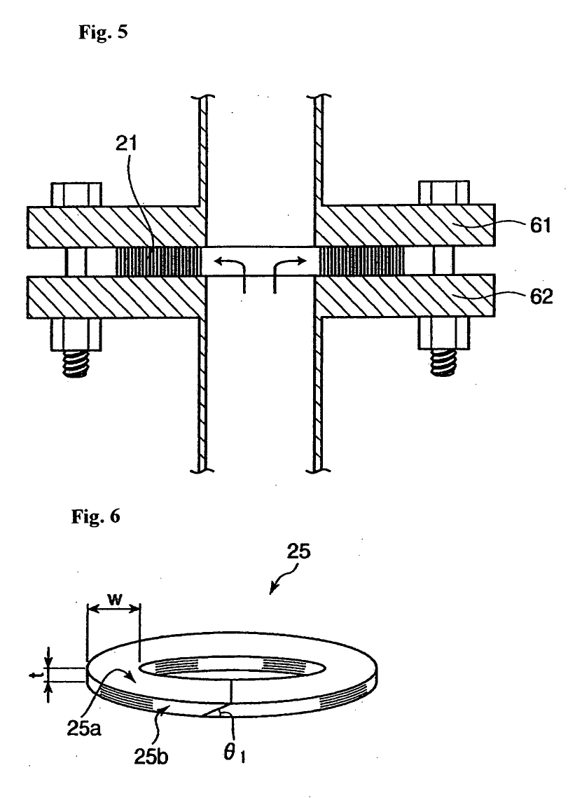

Sealing materials of such description retain a substantially flat shape regardless of whether a band is used, which enables them to be handled in the same manner as punched or other common types of sealing materials. Such attributes are accordingly able to reduce the workload required to install the materials in the locations on flanges or the like that are to be sealed. FIG. 4 is a schematic oblique perspective view depicting a method for installing the aforementioned sealing material 21 on a flange, while FIG. 5 is a schematic oblique perspective view of the flanges where the aforementioned sealing material 21 has been attached. As is illustrated in FIG. 4, removing or otherwise disconnecting the fixing implements (i.e., a nut and bolt in the present example) to slightly separate the flanges 61, 62 will suffice to allow the closed annular sealing material 21 to be inserted into the small gap between flanges 61, 62 when such a closed annular sealing material 21 is used. Accordingly, a minimum of effort needs to be expended as compared with band-shaped sealing materials, in which the flanges 61, 62 must be opened wide to ensure sufficient space is provided for the operation to be carried out.

Moreover, there is no need for the technicians to have a high degree of skill because concerns related to leakage being caused as a result of the failure of the closed ring (i.e., joint failure) are obviated, which stands in contrast to band-shaped sealing materials. Furthermore, metal rings or the like that are commonly fitted for supporting purposes when using closed annular ePTFE sealing materials due their flexibility and large diameters do not necessarily need to be fitted when using the closed annular sealing material of this invention, due to its ability to maintain a prescribed shape. In the present example, the annular flat surface 21a forms the seal surface. When the closed annular sealing material 21 is used on flanges, as shown in FIG. 5, the laminated ePTFE will be orthogonal to the direction of fluid leakage (i.e., the direction shown by the arrows in FIG. 5).

The larger that the width (W) of the annular flat surface becomes relative to the thickness (t) of the sealing material, the more difficult it generally becomes for a substantially flat shape to be maintained; it therefore becomes increasingly important for this invention to be able to maintain a substantially flat shape. The ratio (W/t) between the width (W) and the thickness (t) is, e.g., greater than 1.0, preferably 2 or greater, and ideally 3 or greater. The aforementioned ratio (W/t) is normally 50 or less (e.g., 10 or less).

The aforementioned width (W) may be selected from a range of, e.g., 5 to 100 mm inclusive (preferably between 10 and 75 mm inclusive). The thickness (t) may be selected from a range of, e.g., 0.5 mm or greater (preferably 1.0 mm or greater).

Moreover, when the sealing material assumes a round shape, the smaller the inside diameter (i.e., the diameter of the inner periphery) X becomes relative to the width (W) of the annular flat surface, the more difficult it becomes to maintain a substantially flat shape; it therefore becomes increasingly important for this invention to be able to maintain a substantially flat shape. The ratio (x/W) between the inside diameter (x) and the width (W) is, e.g., 100 or less, preferably 50 or less, and ideally 30 or less. The aforementioned ratio (x/W) is normally, e.g., approximately 3 or more (and in particular, approximately 5 or more).

The aforementioned inside diameter is, e.g., 15 mm or more, preferably 50 mm or more, and ideally 100 mm or more (and in particular, 200 mm or more). There are no particular restrictions as to the upper limit of the inside diameter, but an approximate range of 3000 mm or less is normally required according to need. A substantially flat shape becomes more difficult to maintain as the width (W) increases and as the thickness (t) and inside diameter decrease, which therefore makes it increasingly important for this invention to be able to maintain a substantially flat shape.

Tapered surfaces are formed on the ends 31a, 31b of the band 31 (e.g., refer to FIG. 2), and these tapered surfaces are placed on top of each other and bonded in the sealing material 21 of the aforementioned FIG. 1. Tapering the surfaces prevents with greater assuredness the occurrence of any leakage from the joint 21d. It is additionally possible to enlarge the area of the joining surfaces, and to increase the reliability of the joint. A tapered surface should comprise at least a part of the band joint 21d. For example, the tapered surfaces do not necessarily need to be perfectly overlaid and may indeed be slightly misaligned. There are no particular limitations as to the tapering angle A, which may be, e.g., approximately 5 to 45°. In the example illustrated in the aforementioned FIG. 1, it is possible for the tapered surfaces to be formed on the ends 31a, 31b of the band 31 in the peripheral direction, or for a tapered surface to be only formed on one end.

An alternative method to tapering (e.g., a method of engagement, whereby a V-shaped cut is made on the end of one side, and an inverted V-shaped cut is made on the other end) may be used to enlarge the area of the joining surfaces.

It will be sufficient for surfaces that are substantially rectangular in cross-section to be joined to each other, without the areas of the joining surfaces necessarily needing to be enlarged. As is described hereunder, the closed annular sealing material of this invention is occasionally used as a core material whose surface is covered with sintered PTFE, and in such instances the joint does not necessarily need to be very strong.

There are no particular limitations as to the closed annular sealing material of this invention, provided that the material is made of expanded porous polytetrafluoroethylene (ePTFE); e.g., the material may be made of uniaxially or biaxially expanded PTFE. The microcharacteristics of uniaxially expanded PTFE derive from the presence of narrow nodes in the form of islands (folded crystals) that are roughly orthogonal to the stretching direction, and lattice-shaped fibrils oriented in the stretching direction that serve to form links between these nodes (i.e., straight-chain molecular bundles formed when the aforementioned folded crystals are unraveled and pulled out as a result of the stretching). The microcharacteristics of biaxially expanded PTFE derive from a spider web-like fiber structure in which fibrils extend in a radial fashion, in which the nodes to which the fibrils are linked are interspersed as islands, and in which numerous spaces are defined by the fibrils and nodes.

The average pore diameter of the ePTFE may be appropriately set according to the draw ratio; e.g., approximately 0.05 to 5.0 μm, and preferably 0.5 to 1.0 μm. As shall be described hereunder, the sealing material is formed in this invention by means of laminating ePTFE films, and if the average pore diameter is excessively large, the area of contact between the films will decrease, thereby reducing the adhesion therebetween. As also results if the average pore diameter is excessively large, fluids will be more likely to leak from the interior of the sealing material when passing therethrough (i.e., penetration leakage), thereby degrading the sealability. On the other hand, manufacturing constraints limit further reductions in the average pore diameter.

The average diameter may be measured with a Coulter Porometer (Coulter Electronics, Inc.).

The porosity of ePTFE may be appropriately set according to the draw ratio, and may be selected from a range, e.g., of approximately 10 to 95%, and preferably 30 to 85%. The porosity is preferably selected in accordance with the conditions under which the sealing material will be used (e.g., the roughness of the surface of the tightening members and the tightening force). An increase in porosity will enable a minimum of tightening force to be required for producing sealability even on soft, rough surfaces, while a decrease in porosity will lessen the likelihood of penetration leakage.

The aforementioned porosity may be calculated according to the equation below from the bulk density D (D=W/V; in units of g/cm³), which is determined by means of measuring the weight (W) of the porous PTFE and the apparent volume (V) including the porous regions, and the density D_{standard} (i.e., 2.2 g/cm³ when PTFE resin is used) when no pores at all have been formed.

Porosity (%)=[1−(D/D_{standard})]×100

The closed annular sealing material of this invention may constitute a laminate structure comprising layers of ePTFE films, as well as a non-laminate structure comprising a single relatively thick ePTFE film (i.e., tape). The material may be fashioned into a laminate structure by means of using a laminated band comprising layers of uniaxially or biaxially expanded ePTFE films. Closed annular sealing materials are preferably of the laminate structure type (especially when biaxially expanded ePTFE is used).

There are no particular limitations as to the thickness of the ePTFE film, which may be, e.g., between 5 and 500 μm inclusive (and in particular between 15 and 150 μm inclusive).

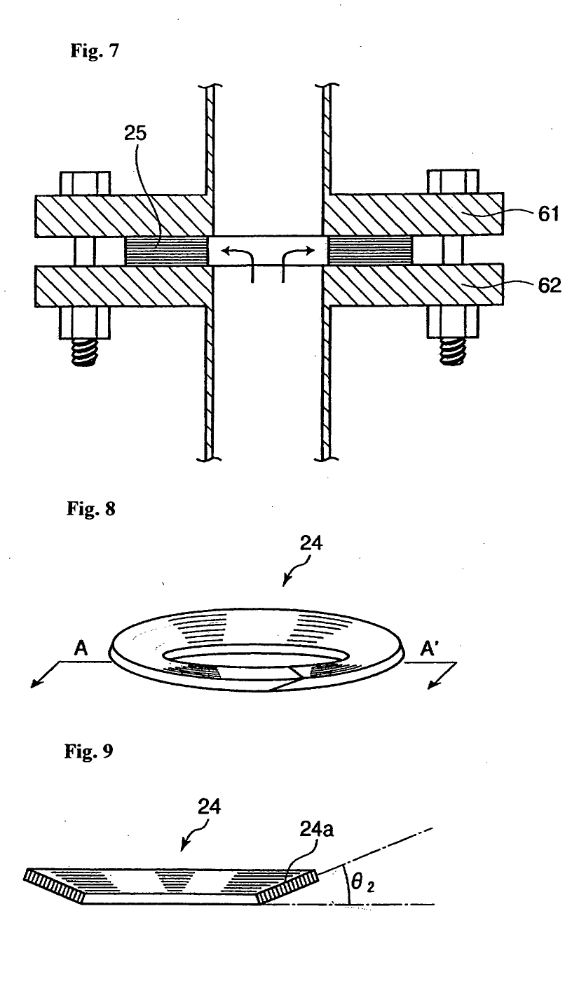

The ePTFE film may be laminated in the width (W) direction of the annular flat surface 21a as shown in the aforementioned FIG. 1, but may also be laminated in the thickness (t) direction of the sealing material. FIG. 6 is a schematic oblique perspective view of such a sealing material 25, and FIG. 7 is a schematic oblique perspective view showing the sealing material 25 in an attached state. When using a sealing material 25 comprising an ePTFE film laminated in the thickness (t) direction of the outer peripheral surface 25b (i.e., in the thickness direction of the sealing material), as is shown in FIGS. 6 and 7, the ePTFE layers will lie parallel to the direction of fluid leakage (i.e., the direction indicated by the arrows in FIG. 7). As a result of setting the tightening load high, the pores can be crushed and the penetration leakage prevented in such circumstances as well. Sealing materials made of biaxially expanded PTFE are preferably used when the ePTFE film layers are laminated in the thickness (t) direction. Using biaxially expanded PTFE enables the strength to be increased in the width (W) direction of the annular flat surface 25a, and enables creep (cold flow) deformation caused by the tightening action to be inhibited.

ePTFE sealing materials are exceptionally flexible, and are highly effective in preventing leakage (i.e., interfacial leakage) from gaps between the material and the flange or other member to be sealed, but if a small tightening load has been applied, their porous structure will occasionally lead to the occurrence of penetration leakage, such as described in the foregoing. It is accordingly desirable for a film having a non-porous structure to be used in concert with the sealing material of this invention in order to assuredly prevent penetration leakage. When the closed annular sealing material of this invention is used as a core material, for example, penetration leakage may be assuredly prevented if the surfaces thereof (e.g., the inner peripheral surface and the annular flat surface) are covered with sintered PTFE. When the ePTFE film has been laminated in the width (W) direction, such as in the sealing material 21 in the aforementioned FIG. 1, substituting a part of the ePTFE film with a non-porous film will enable the non-porous film to be arranged orthogonally with regard to the direction of fluid leakage, as shown in FIG. 5, and thereby assuredly prevent penetration leakage from occurring. Sealing materials in which such films with a non-porous structure are incorporated are especially useful in providing a seal against fluids that are more difficult than water-based solvents to prevent from leaking; e.g., organic solvents, gases, and the like.

Examples of the aforementioned non-porous films that may be used include a variety of synthetic resin films in additional to metallic films (metallic foils), but preferably include fluororesin films (e.g., films made of polytetrafluoroethylene (PTFE), tetrafluoroethylene-hexafluoropropylene (FEP), and tetrafluoroethylene-perfluoroalkylvinylether copolymer), and in particular, preferably include PTFE films (e.g., sintered PTFE films, unexpanded PTFE films, and films in which the ePTFE has been compressed or otherwise compacted (dense PTFE films))

The sealing materials described in the aforementioned drawings all depict a single band that is joined in a single location; however, in alternative configurations a plurality of bands (e.g., two) may be joined in a plurality of locations (e.g., two).

There are no particular limitations as to the shape of the ring of the sealing material of this invention, provided that the ring is closed, with the shape able to be suitably selected according to the shape of the member to be sealed (e.g., a flange). Examples of shapes that may be selected include substantially circular (e.g., circular, elliptical, and track-shaped) and substantially polygonal (e.g., rectangular).

The annular portion 21a [sic] in the aforementioned closed annular sealing material 21 is completely flat, but may alternatively be slanted. FIG. 8 is a schematic oblique perspective view depicting such a sealing material 24, and FIG. 9 is a cross-sectional view of the sealing material 24 in FIG. 8 along line A-A′. These materials may be used in the same manner as punched or other common sealing materials even if the angle of elevation (i.e., the angle of inclination relative to the horizontal plane) θ₂ of the annular portion 24a is not 0° (i.e., even if the annular portion is slanted). Nevertheless, if the angle of elevation θ₂ is too large, the material will become more difficult to use; it is therefore desirable for θ₂ to be 45° or less, preferably 20° or less, and ideally 10° or less (and in particular, 0°).

The closed annular sealing material of this invention may be broadly categorized into two types according to the method of manufacture thereof (detailed descriptions of the methods shall be provided hereunder). In other words, the manufacturing methods include those where the aforementioned angle of elevation is 0 to 45° (i.e., methods in which the angle may be 0°, but may also be greater than 0°), and those where the angle is definitely 0°; it is therefore possible to classify the closed annular sealing materials into those having a 0 to 45° angle of elevation and those having a 0° angle of elevation. Further characteristics of the closed annular sealing materials shall be described below according to this classification.

As shall be described hereunder, a closed annular sealing material having a 0 to 45° angle of elevation is manufactured from an expanded porous polytetrafluoroethylene band. The size of the expanded porous polytetrafluoroethylene band is described based on a coordinate system comprising the width (W) direction, thickness (t) direction, and peripheral direction of the sealing material (i.e., the sealing material coordinate system), whereby the length thereof in the thickness (t) direction is smaller than the width (W) direction, and a band having a short length in the thickness (t) direction is referred to as “a thin band.” A closed annular sealing material having a 0 to 45° angle of elevation may be manufactured as a result of bending the aforementioned thin band in the width (W) direction (based on the sealing material coordinate system; i.e., once the material has been bent in a plane orthogonal to the thickness (t) direction), pre-fixing the band in order to maintain this bent shape, and thermosetting the band. There are no particular limitations as to the timing of the ring-closing procedure, which may be performed before, during or after the thermosetting.

It is desirable for closed annular sealing materials having a 0 to 45° angle of elevation to have an adhesive layer formed on one of the annular flat surfaces (e.g., on the annular flat surface 21a and/or the annular flat surface on the reverse side of same in the case of the seal shown in the aforementioned FIG. 1). Forming such an adhesive layer, especially when the annular flat surface (annular portion) is slanted, will enable the material to be laid flat without any difficulty when same is attached to the member to be sealed, thereby further enhancing the ability of the material to be handled.

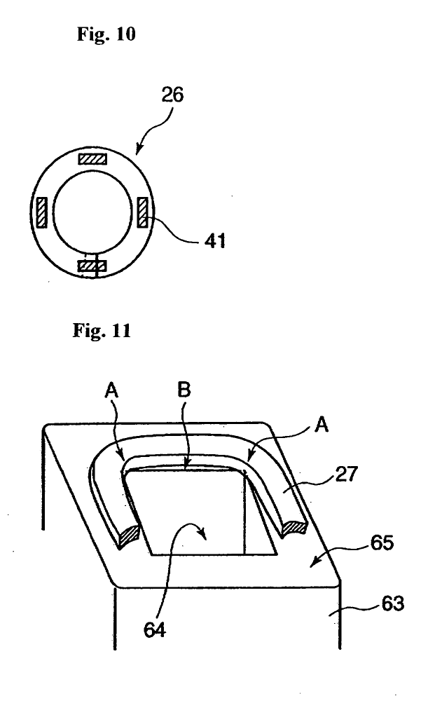

The adhesive layer may be formed over the entirety of one of the annular flat surfaces, or on portions thereof. If the layer is to be formed in portions thereon, it is desirable for a plurality of adhesive regions to be formed and located essentially equidistantly from each other. For example, four adhesive regions 41 are formed and located essentially equidistantly from each other in the sealing material 26 shown in FIG. 10.

There are no particular limitations as to the type of adhesive layer, provided that the layer can bond to the sealing material of this invention, with acrylic adhesives and rubber adhesives being applicable examples. Acrylic adhesives are preferred when heat-resistance and other attributes are taken into consideration.

There are no particular limitations as to the thickness of the adhesive layer, with a typical thickness being from approximately 3 to 200 μm, and preferably from approximately 5 to 25 μm.

The surface of the adhesive layer may ordinarily be covered with a release sheet. Any known release sheet may be used therefor, with preferred examples including polyethylene and polypropylene films and other resin films that have exceptional release properties, as well as those in which a silicone resin, fluororesin or another release agent has been applied on or impregnated into a paper or resin film (e.g., a polyester or polyimide film).

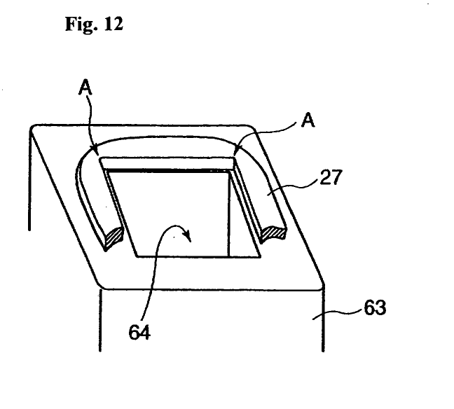

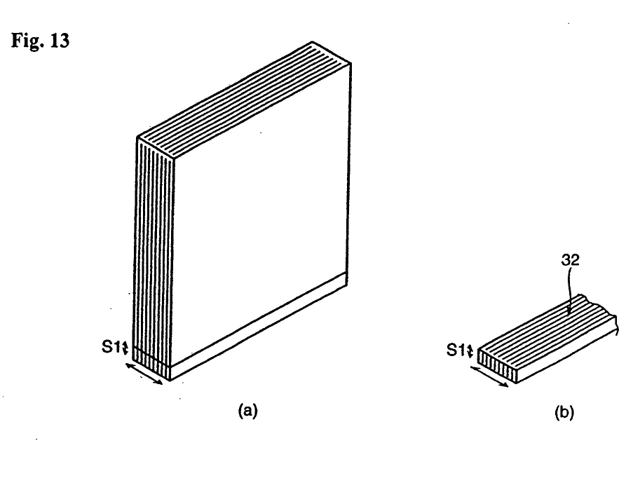

Closed annular sealing materials having a 0 to 45° angle of elevation may assume a substantially polygonal shape (e.g., rectangular), such as has been described in the foregoing, but it is desirable for the inner peripheral sides of the corner portions to be cut away as required. FIG. 11 is a schematic oblique perspective view depicting a substantially polygonal closed annular sealing material 27, with a portion thereof having been removed, before the inner peripheral sides of the corner portions have been cut away, in which example a rectangular shape is illustrated. A rectangular closed annular sealing material 27 is disposed on a rectangular flange 63 in this example. As is evident from FIG. 11, the corner portions A of the polygonal sealing material will not normally form a perfect angle, but will instead bulge slightly. Accordingly, the association between the flange 63 and the channel 64 will cause fluids to flow erratically because the corner portions A will not remain in contact with the tightening surface 65, but protrude into the channel 64. Furthermore, should the sealing material 27 be used on a flange whose channel is even smaller than the flange 63, the fluid-trapping regions B will occasionally become excessively large, although the aforementioned fluid leakage and other problems will be able to be prevented. By contrast, as shown in FIG. 12, cutting away the inner peripheral sides of the corner portions A so as to form a perfect angle will enable the shape of the inner periphery of the sealing material to approximate that of the channel 64 in the flange 63, and the erratic flow, fluid trapping, and other related problems to be minimized.

When rectangular closed annular sealing materials are formed from closed annular sealing materials having a 0 to 45° angle of elevation, and the inner peripheral sides of the corner portions thereof are not cut away, the radius of the inscribed circle thereof (i.e., the corner radius) R is ordinarily greater than about 10 mm (e.g., 15 mm or greater, and in particular, 20 mm or greater).

As shall be described hereunder, the thick bands (and/or thick boards) made of expanded porous polytetrafluoroethylene that are used in closed annular sealing materials having a 0° angle of elevation are thicker than those used when the aforementioned closed annular sealing materials having a 0 to 45° angle of elevation are manufactured. In other words, the length of these thick bands and/or boards (collectively referred to as “thick articles”) in the thickness (t) direction (based on the sealing material coordinate system) is equal to or greater than the width (W) of the sealing material. The manufacturing procedure involves bending the thick article in the width (W) direction (based on the sealing material coordinate system), pre-fixing the thick article in order to maintain the bent shape, and thermosetting it. There are no particular limitations as to the timing of the ring-closing procedure, which may be performed before, during or after the thermosetting. A closed annular sealing material having a 0° angle of elevation is manufactured by means of slicing the thick article (with a closed annular article being acceptable) to a prescribed thickness (t) after the thermosetting procedure.

The angle of elevation of the closed annular sealing material obtained as described in the foregoing may be assuredly made 0° even if the conditions governing the ratio of the width (W) to the thickness (t) (i.e., the ratio (W/t)) and the ratio of the inside radius (X) and the width (W) (i.e., the ratio (x/W)) are more restrictive than in the aforementioned range. For example, the ratio (W/t) may be five or greater (especially 10 or higher), while the ratio (x/W) may be 15 or less.

Closed annular sealing materials having a 0° angle of elevation are characterized in being able to yield precisely formed corners when formed into substantially polygonal closed annular sealing materials (e.g., rectangular closed annular sealing materials). For example, the radius R of the inscribed circle in the inner periphery of the corner portions of a rectangular sealing material (i.e., the corner radius) may be 10 mm or less, preferably 5 mm or less, and ideally 0 mm. With such a closed annular sealing material, the substantial seal width (W) of the corner portions is larger than in sealing materials in which the inner peripheral sides of the corner portions are cut away to precisely form the inner peripheries of the corner portions, or in sealing materials in which a notch is made in the inner peripheral sides of the corner portions to make a precise bend in the corner portions. Therefore, exceptional sealability is obtained and the corner portions are endowed with exceptional strength due to a structure that inhibits stresses from being concentrated thereon, even when the corner portions are under tension. Additionally, the PTFE yield may be increased, and it is possible to dispense with work normally involved in cutting away, notching, and otherwise working the materials.

The adhesive layers, release sheet, and other components described in relation to the closed annular sealing materials having a 0 to 45° angle of elevation are not normally required when using closed annular sealing materials having a 0° angle of elevation, but adhesive layers or release sheets may be provided thereto as required. For example, the provision of an adhesive layer to large-diameter sealing materials having an inner radius of approximately 1000 mm or larger will simplify the positioning of the materials when they are to be attached.

A method for manufacturing closed annular sealing materials having a 0 to 45° angle of elevation is described hereunder, after which a method for manufacturing closed annular sealing materials having a 0° angle of elevation shall be described.

Closed annular sealing materials having a 0 to 45° angle of elevation are manufactured from ePTFE bands that are relatively thin (i.e., the length in the thickness (t) direction (based on the sealing material coordinate system) is less than the width (W) of the closed annular sealing material). In other words, these materials are manufactured as a result of bending one or a plurality of thin ePTFE bands in the width direction (i.e., bending the thin band in the plane orthogonal to the thickness (t) direction (based on the sealing material coordinate system)) to form a ring as a whole, pre-fixing the band in order to maintain the bent shape, and thermosetting the band. The ends of the aforementioned thin band may be joined before, during, or after the thermosetting.

The angle of elevation of the sealing material can be kept at 0 to 45° without being increased to approximately 90°, because once the thin band has been bent in the plane orthogonal to the thickness (t) direction (i.e., once the circle has been formed into a substantially flat shape) when being bent so as to be formed into a circle as a whole, the band is thermoset while having been prefixed in order to allow the substantially flat shape to be retained. Although there is no apparent reason specifically as to why the substantially flat shape can be retained (i.e., the angle of elevation kept at 0 to 45°) even when the pre-fixing has been removed after thermosetting, it is presumed that the thermosetting can eliminate the residual stresses generated during the ring-forming procedure (i.e., during the formation of the substantially flat shape).

A method for manufacturing closed annular sealing materials having a 0 to 45° angle of elevation is described in detail hereunder.

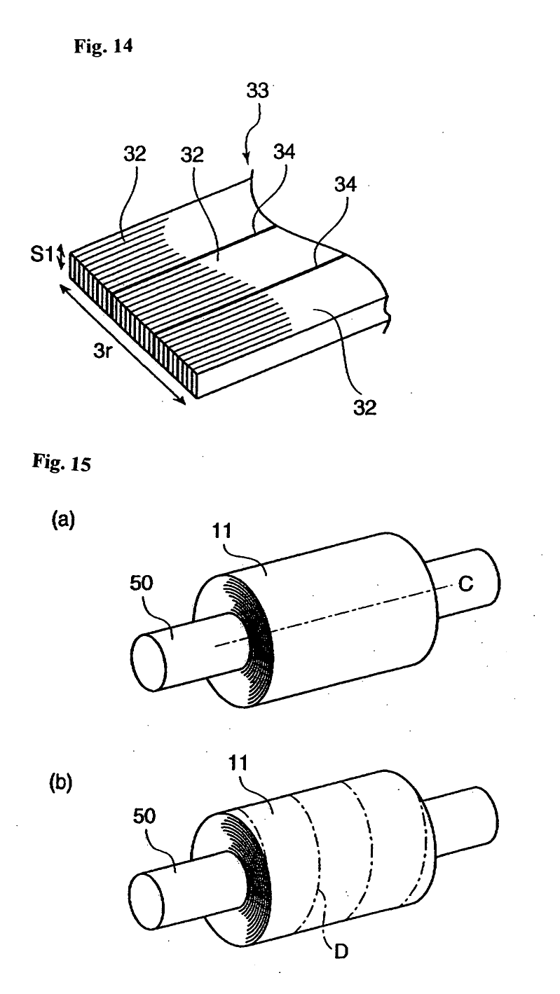

ePTFE bands (“thin bands”) may comprise a non-laminate structure, as has been described in the foregoing, but it is desirable for a laminate of ePTFE films to be employed. There are no particular limitations as to the method used for manufacturing such laminate bands, nor are there any particular limitations as to the direction of lamination, and the manufacturing procedure may be performed as illustrated by way of example in FIGS. 13 through 15. In other words, referring to the example in FIG. 13, a prescribed number of ePTFE films are laminated to form a flat-board laminate of width r, as shown in FIG. 13(a), and the laminated band 32 shown in FIG. 13(b) is obtained by means of cutting the flat-board laminate to a prescribed height S1. The ePTFE films in the laminated band 32 are laminated in the width (W) direction. The aforementioned cutting height S1 is the same as the thickness (t) of the sealing material (i.e., S1=T), and therefore remains smaller than the width (W) of the sealing material.

In the example illustrated in FIG. 14, a laminated band 33 is obtained by means of layering a plurality of laminated band units 32 (three in this instance) obtained in the same manner as in the aforementioned FIG. 13, and joining same together via joining layers 34 (to be described in detail hereunder). The ePTFE films are also laminated in the width (W) direction in the laminated band 33. The joining layers 34 do not necessarily have to be provided, and the units can be joined directly together by means of heat fusion.

In the example illustrated in FIG. 15(a), a cylindrical laminate 11 comprising ePTFE film is manufactured by means of windingly laminating the ePTFE film onto a mandrel 50. The cylindrical laminate 11 is cut open along the axial direction of the mandrel 50 (i.e., along dotted line C in FIG. 15(a)) to produce a flat-board laminate, which is then cut to a prescribed width in the same manner as employed in the aforementioned example shown in FIG. 13 to yield a laminated band. In the example illustrated in FIG. 15(b), the peripheral surface of the aforementioned cylindrical laminate 11 is cut into a helical shape (i.e., along dotted line D in FIG. 15(b)) to produce a laminated band similar to the aforementioned example illustrated in FIG. 13.

When the thin ePTFE band is bent to form a ring as a whole, the ring may be formed into a flat shape (i.e., as in FIG. 1) or a vertical cylindrical shape (i.e., as in FIG. 3). A ring that has been formed into a vertical cylindrical shape may also be flattened by means of extending the side wall of the closed annular article outwardly in the form of a flange.

When rings are formed as has been described in the foregoing, the ends of the band may be joined to each other prior to the thermosetting to completely close the ring; however, it is also possible for the band to appear to be closed (i.e., a temporary closure), with the ends of the band not being joined completely to each other before the thermosetting, whereupon the aforementioned ends can be joined to each other after the thermosetting to completely close the ring. It is also possible for the ends to be joined to each other during the thermosetting to completely close the ring.

Once bent, the ePTFE band must be prefixed prior to thermosetting, as has been described in the foregoing. One reason for this requirement is that if the band has been provisionally closed (i.e., temporarily closed) without having been completely closed, the band will remain in an undefined shape if pre-fixing has not been performed thereon. A further reason is that when the ring has been completely closed, stresses will act on the outer peripheral surface in the direction of contraction, thereby causing the band to deform readily into a vertical cylindrical shape (e.g., as in FIG. 3).

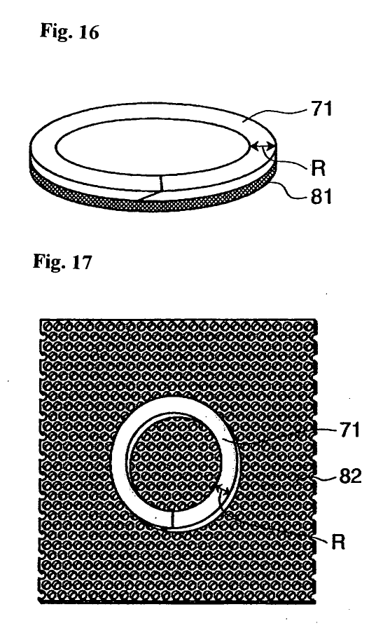

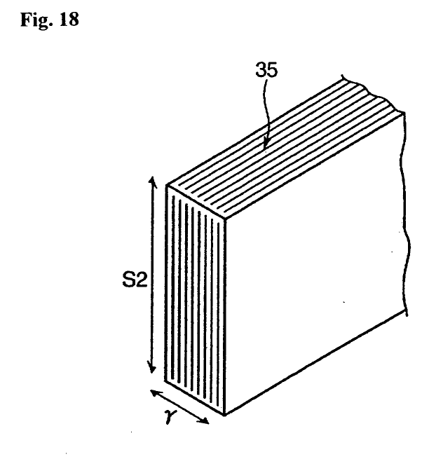

In the pre-fixing process, it is desirable for bands that have been formed into a ring to be fixed to a support, with examples of such supports including rigid plates made of metal or the like, similar rigid plates provided with a plurality of small holes (e.g., punched metal or other punched plates), and other plate-shaped supports; and ring-shaped supports such as ring-shaped metal plates. FIGS. 16 and 17 are schematic diagrams used to provide a more specific description of the pre-fixing process. In the example illustrated in FIG. 16, a band 71 that has been formed into a ring has been prefixed to a ring-shaped plate 81 of substantially the same configuration, while in the example illustrated in FIG. 17, the band has been prefixed to punched metal 82. Using a plate made of punched metal or the like provides convenience, since the circle may therefore be set to any planar configuration (e.g., round, elliptical, or rectangular).

There are no particular limitations as to the technique with which the band is fixed to the support, with relevant examples including bonding means (e.g., an adhesive or adhesive tape), fastening means (e.g., a rope or tape), clamping means (e.g., clips), and slippage-preventing means (e.g., pins). When employing bonding means, it is desirable for the degree of adhesiveness thereof to allow the annular article and the supporting plate to be separated after the thermosetting.

Once the thermosetting is complete, the article is cooled to approximately room temperature as required, after which the support is removed. The annular band will be creased after thermosetting, and its configuration will be set. The closed annular sealing material of this invention may be obtained by means of completing the thermosetting in cases in which the ends of the band have been joined to each other either before or during the thermosetting. On the other hand, the closed annular sealing material of this invention may also be obtained by means of joining the ends of the band with each other after thermosetting, if they have not been joined to each other. If the joining (i.e., ring closing) is performed after the thermosetting, the annular portion may become slanted after the circle is closed, depending on the state of separation of the two ends, and this configuration has also been included in this invention.

ePTFE articles that are relatively thick (i.e., the length in the thickness (t) direction (based on the sealing material coordinate system) is greater than the width (W) of the closed annular sealing material) are used for closed annular sealing materials having a 0° angle of elevation (e.g., thick bands and thick boards that are made of ePTFE). These materials may be manufactured as a result of bending one or a plurality of thick ePTFE articles as described in the foregoing in the width (W) direction (based on the sealing material coordinate system; i.e., bending the article in the plane orthogonal to the thickness (t) direction (based on the sealing material coordinate system)) to form a ring as a whole, pre-fixing the thick article in order to maintain the bent shape, and thermosetting and subsequently slicing the thick article (or a closed annular modification thereof) to a thickness (t) that is same as that of the sealing material (i.e., that is less than the width (W) of the sealing material). The ends of the aforementioned thick article or sliced article may be joined to each other before, during, or after the thermosetting. The joining is preferably performed after slicing.

The manufacture of closed annular sealing materials having an angle of elevation of 0°, as opposed to the manufacture of the aforementioned sealing materials having an angle of elevation of 0 to 45°, is characterized by the use of thick thermoset ePTFE articles. Thick articles that have been bent and thermoset are subsequently sliced to a prescribed thickness (t), whereupon the angle of elevation of the sealing materials is securely kept at 0°.

The length of the thick articles in the thickness (t) direction (according to the coordinate system for sealing materials) should be greater than or equal to the width (W) of the closed annular sealing material, preferably greater than or equal to 1.2 times the width (W) of the sealing material, ideally greater than or equal to approximately 1.5 times as large, and in particular greater than or equal to 2 times as large. The length in the aforementioned thickness (t) direction is, e.g., 5 mm or more, and particularly 10 mm or more (and even more particularly 30 mm or more). There are no particular restrictions as regards the upper limit thereof, which is normally approximately 500 mm or less (e.g., 300 mm or less).

Thick articles are used when sealing materials having a 0° angle of elevation are manufactured, which means that the articles must be sliced to the sealing material thickness (t) at an appropriate stage following thermosetting.

The use of thick articles requires the method for manufacturing closed annular sealing materials having a 0° angle of elevation to involve some aspects (in addition to the aspects described in the foregoing) that are different from the method used to manufacture closed annular sealing materials having a 0 to 45° angle of elevation. These different aspects are described below in detail (with the aspects that are common to the method for manufacturing closed annular sealing materials having a 0 to 45° angle of elevation being omitted from the description).

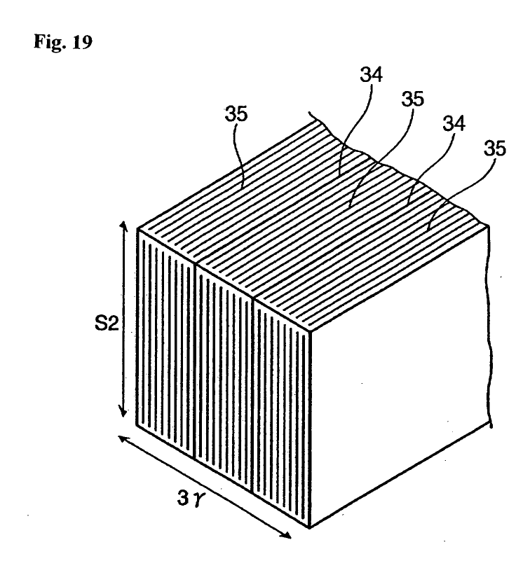

As with closed annular sealing materials having an angle of elevation of 0 to 45°, it is also desirable to use laminated articles comprising ePTFE film as the ePTFE band in closed annular sealing materials having an angle of elevation of 0°; however, the laminated band is thick, which is unlike when closed annular sealing materials having a 0 to 45° angle of elevation are manufactured. The laminated band 35 shown in FIG. 18, in particular, is used instead of the band shown in the aforementioned FIG. 13(b). In other words, the cutting height S2 is greater than the cutting height S1 of the aforementioned laminated band 32, and will be greater than the width (W) in the resulting sealing material. As with the laminated band 32 in FIG. 13(b), the ePTFE film in the laminated band 35 of FIG. 18 is laminated in the width (W) direction. As with closed annular sealing materials having an angle of elevation of 0 to 45°, a plurality of laminated band units 35 may also be layered (i.e., as in FIG. 19) in closed annular sealing materials having an angle of elevation of 0°; laminated bands may also be manufactured from flat-board laminates that have themselves been manufactured from cylindrical laminates 11 comprising an ePTFE film that has been wound and laminated on a mandrel, or manufactured directly from the cylindrical laminates 11 comprising ePTFE film.

ePTFE bands may also be prefixed in the same manner employed when the aforementioned closed annular sealing materials having an angle of elevation of 0 to 45° are manufactured, but it is recommended that the pre-fixing be performed as described hereunder.

(1) One-Time Pre-Fixing Method

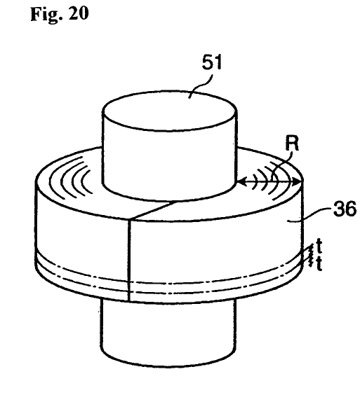

FIG. 20 illustrates an example of a recommended method. In other words, the recommended method involves winding a thick ePTFE band 36 onto a mandrel (having a round cross-section in the present example) 51. In the present example, the ends of the thick band 36 are tapered, and are joined to each other via the tapered surfaces. In circumstances where the ends are not joined to each other (or as otherwise dictated by necessity when the ends have been joined to each other), it is desirable for the ePTFE band to be pressed against a support rod 51 with a suitable member. In the example shown in FIG. 20, an article laminated from ePTFE film is used as the thick band 36, with the ePTFE film having been laminated in the width (W) direction.

The cross-sectional shape of the mandrel, which is not subject to any particular limitation, may be selected from among substantially round shapes (e.g., circular, elliptical, and track configurations) and substantially polygonal shapes (e.g., rectangular).

The article is sliced to the thickness (t) of the sealing material (i.e., along the dotted line in FIG. 20) after the thermosetting.

(2) Method for Pre-Fixing a Plurality of Thick Articles Using Parts

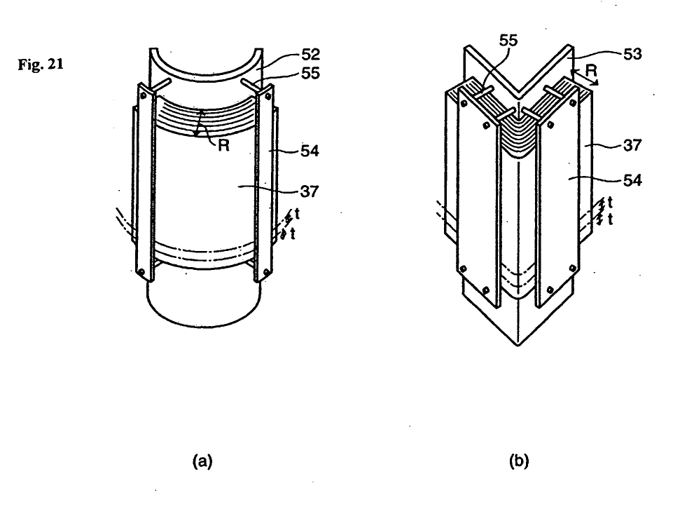

FIG. 21 illustrates an example of a recommended method. In other words, the recommended method involves a thick ePTFE article 37 being pressed against a support having a suitable shape (i.e., an arcuate support plate 52 in the example of FIG. 21(a), and a square support plate 53 in the example of FIG. 21(b)) by means of a suitable presser 54, to pre-fix the thick article 37. In the example shown in FIG. 21, an article laminated from ePTFE film is used as the thick article 37, with the ePTFE film having been laminated in the width (W) direction.

In the examples illustrated in the aforementioned drawings, the presser 54 is pressed against the supports 52, 53 using bolting means 55; however, a variety of alternative means for producing a pressing force may be employed in addition to bolting means. The presser 54 and supports 52, 53 are not limited to the shape of a plate, with a variety of pressers and supports being applicable.

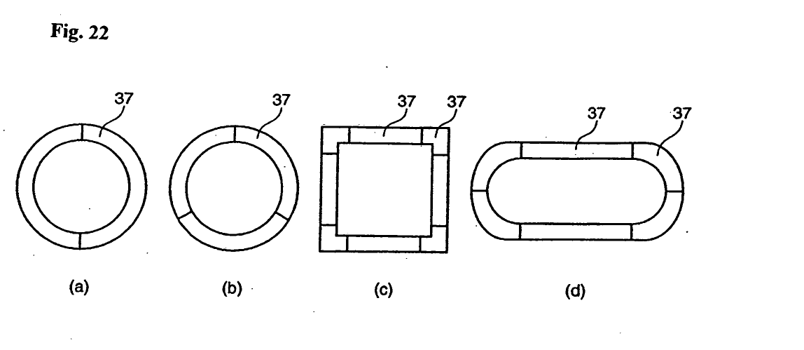

It is essential for a ring to be able to be formed as a whole (i.e., in instances in which a plurality of parts are used and the ring is assembled from these parts), even when a plurality of thick articles is prefixed for each part. For example, the configurations shown in FIG. 22 should be employed when manufacturing annular, rectangular, or track-shaped sealing materials. FIG. 22 illustrates plan views of thick articles as seen from the direction of height S2 once the parts have been assembled. In FIG. 22(a) and (b), arcuate thick articles 37 have been assembled to form a ring as a whole. In FIG. 22(c), angled (bracket-shaped) thick articles 37 have been assembled in combination with linear thick articles 37 to form a rectangular shape as a whole. In FIG. 22(d), arcuate thick articles 37 have been assembled in combination with angled (bracket-shaped) thick articles 37 to form the shape of a track as a whole. The configuration of the parts is not limited to the examples illustrated in the aforementioned drawings, and may indeed comprise a variety of arrangements.

After the thermosetting, the articles are sliced to the thickness (t) of the sealing material (i.e., along the dotted lines in FIGS. 21(a) and (b)) at an appropriate stage.

It is recommended that the following means also be adopted when manufacturing rectangular sealing materials. Adopting the following means will facilitate the reduction of the corner radii.

In other words, it is desirable to preheat thick bands when such bands are to be prefixed to a rectangular support (e.g., a mandrel or support plate 53). Preheating will soften the thick bands by an appropriate degree, and enable them to be tightly bonded to the corner portions of the rectangular support. The temperature during the aforementioned preheating is, e.g., approximately between 50° C. and 150° C. inclusive (and preferably between 80° C. and especially 120° C. inclusive). If the pre-heating temperature is too high, the band will contract.

When using the support plate 53 as in the example illustrated in FIG. 21(b), it is desirable to use a presser 54 that can be pressed against substantially the entire straight region. The corner radii may be reduced pressing the presser against roughly the entire region except for the non-corner portions (i.e., the straight portions).

[Universal Conditions]

It is recommended that the following procedures be followed when using any of the aforementioned methods of manufacture.

Described hereunder is a method for obtaining the ePTFE to be employed. In other words, the ePTFE may be obtained by means of molding PTFE fine powder while the powder is mixed with a molding auxiliary, removing the molding auxiliary, stretching the resulting article at a high speed and/or high temperature, and optionally sintering the article. Additional information on this method is provided in Japanese Examined Patent Application (Kokoku) 51-18991.

The ePTFE bands may be of a non-laminate structure, but bands laminated from ePTFE film are desirably used.

If laminated ePTFE bands are to be manufactured by means of cutting laminated articles that comprise ePTFE film, it is desirable for the films to be sintered at an appropriate stage (particularly before the bands are cut) to bond them tightly together. The sintering temperature is preferably equal to or greater than the melting point of polytetrafluoroethylene, particularly 327° C., and especially 350° C. or higher. An excessively high sintering temperature will cause the PTFE resin to be subjected to heat degradation and porosification; it is therefore preferable for the sintering temperature to be 400° C. or less, and in particular 380° C. or less.

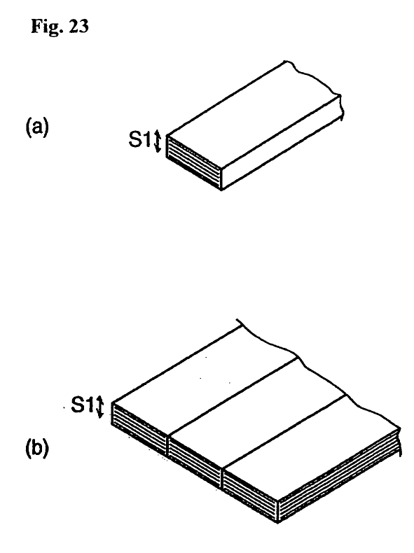

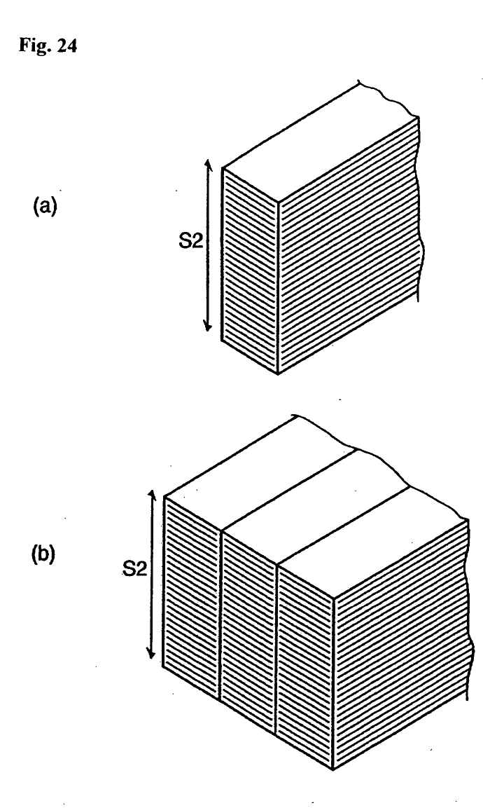

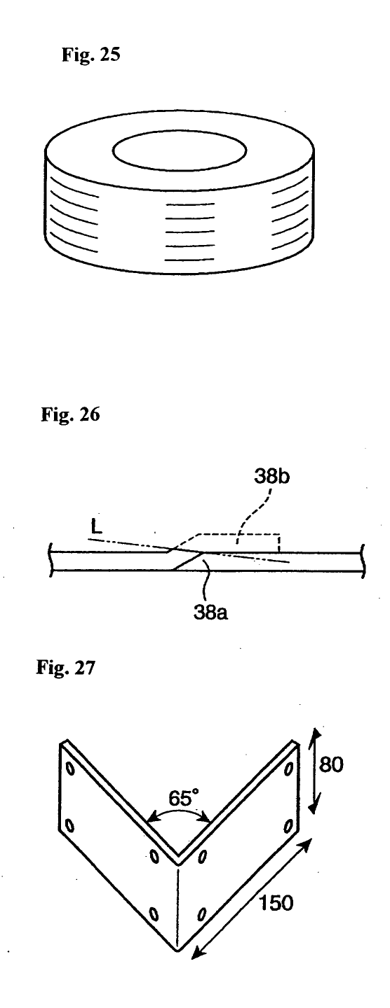

There are no particular limitations as to the direction in which the ePTFE films are laminated in the laminated ePTFE band. In the aforementioned manufacturing example, the ePTFE films in all of the sealing materials are laminated in the width (W) direction, but the ePTFE may alternatively be laminated in the thickness (t) direction of the sealing materials. For example, the laminate structures shown in FIGS. 23(a) and (b) may be substituted for those in FIGS. 13(b) and 14, the laminate structures shown in FIGS. 24(a) and (b) may be substituted for those in FIGS. 18 and 19, and the laminate structure shown in FIG. 25 may be substituted for that in FIG. 20. If the ring is to be closed before the thermosetting, there will be scant correlation between the ease with which the ring is closed and the direction in which the ePTFE films have been laminated. In other words, the ease with which the ring is closed will remain approximately the same, irrespective of the direction in which the ePTFE films have been laminated.

When laminating a plurality of ePTFE laminate units 32, 35 and the like, such as shown in FIGS. 14, 19, 23(b) and 24(b), the respective units may be joined via joining layers 34, or the laminate units may be directly heat-fused without the joining layers 34 having been inserted therebetween. Examples of the aforementioned joining layers include double-sided adhesive tape, adhesive, and plastic film. Plastic film in particular can function as a film of a non-porous structure that will prevent penetration leakage, such as has been described in the foregoing. Examples of preferred plastic films include tetrafluoroethylene-hexafluoropropylene copolymerized film (FEP film), tetrafluoroethylene-perfluoroalkylvinylether copolymerized film (PFA film), and other fluororesin films. Fluororesin films have exceptional heat- and chemical-resistance.

The ends of the ePTFE bands may be joined to each other before, during, or after the thermosetting to close the ring. If the ends are to be joined to each other during or after the thermosetting, then a provisional ring (i.e., a temporary ring) may be formed before thermosetting, and the ring closed completely after thermosetting as a result of joining the aforementioned ends to each other.

When an ePTFE band is to be joined, either or both ends thereof may be tapered; it is alternatively possible for neither end to be tapered. Before the ePTFE band is joined, an end on one side may be laid on top of the other end when the ends of the band are overlapping (especially before thermosetting). As shown in the schematic side view of FIG. 26 for example, the untapered end 38b on one side is laid on top of the tapered end 38a on the other side. The assembly may be used as a sealing material even if the end 38b is superposed by means of cutting the band (especially after thermosetting) along line L in order to eliminate the unevenness. There are no particular limitations as to the line along which the unevenness is cut off, provided that any leakage that would have been attributable to the unevenness can be prevented; e.g., the cutting line may lie in the same plane as the annular flat surface. The example shown in FIG. 26 depicts a band that has a tapered end on one side, but the tapering is not necessarily required.

A variety of means may be adopted for joining the ends of ePTFE bands to each other, with relevant examples including heat-fusing the ends together and using (interposing) the joining layers described in the foregoing to join the ends together.

If plastic films are used, they may, e.g., be interposed between the ends of the band, which are joined to each other by means of heat fusion or ultrasonic welding. The ends can be joined to each other during the thermosetting if the plastic film has a lower melting point than the thermosetting temperature.

The thermosetting temperature is, e.g., 50° C. or higher (and preferably 80° C. or higher). Higher temperatures will enable the materials to retain their configuration, but it is desirable for the thermosetting temperature to be 400° C. or less (and preferably 200° C. or less).

There are no particular limitations as to the heating means able to be used for thermosetting, with examples including radiant heating using a heating furnace, conduction heating using a hot plate (and in particular contact heating while pressure is applied with the hot plate), and convective heating using a heating medium (e.g., air or steam).

There are no particular limitations as to the duration of thermosetting, provided that the configuration of the article can be maintained. The duration will vary according to such aspects as the heating method and band size, and is, e.g., approximately 0.5 to 3 hrs.

It is desirable for the annular flat region of the closed annular sealing material of the invention obtained as has been described in the foregoing to be used as a sealing surface, although the outer peripheral surface thereof may also be used as a sealing surface. The closed annular sealing material of this invention may be employed in a variety of locations where a fluid seal is required; e.g., in joints (e.g., flanges) for pipes and vessels (e.g., tanks), and manhole covers. The material may additionally be used as a sealing material for components that come into contact with industrial equipment.

This invention is described in detail below with reference to embodiments; however, this invention shall not be construed to be limited to these embodiments. It is entirely possible to implement the invention after having made any appropriate modification thereto that remains within a scope conforming to the main points thereof as described in the foregoing or hereunder, with all of such modifications taken to be incorporated within the technical scope of this invention.

### EXAMPLES

### Examples 1 through 9

Band 1 (Made of Biaxially Expanded PTFE)

A sheet laminated from biaxially expanded PTFE films (thickness: 4 mm; sold commercially by Japan Gore-Tex, Inc. under the trade name “Gore-Tex Hyper-Sheet”) was cut to produce a band (i.e., a tape) that had a width of 25 mm, a length of 3,000 mm, and a height S1 of 4 mm (with the direction of ePTFE film lamination being the height (S1) direction, which is the thickness (t) direction; e.g., refer to FIG. 23(a)).

Band 2 (Made of Biaxially Expanded PTFE)

(1) Manufacture of ePTFE Film

22 weight parts solvent naphtha was blended with 100 weight parts polytetrafluoroethylene powder (i.e., fine powder) obtained by means of emulsion polymerization, and the resulting resin paste was fashioned into a film. The film molded from the paste was heated to a temperature (200° C. in the present example) equal to or higher than the boiling point of the solvent naphtha, and the solvent naphtha was evaporated off. The resulting article was subsequently expanded biaxially (200% in the takeup direction and 1000% in the direction orthogonal to the takeup direction) at a temperature (300° C. in the present example) equal to or less than the melting point of the polytetrafluoroethylene, to yield an ePTFE film having a thickness of 60 μm and a porosity of 80%. The aforementioned expanding was performed at a speed whereby the film was stretched at a ratio of 10% or more per second (approximately 10% in the present example).

(2) Manufacture of Non-Porous Film

Three sheets of the aforementioned ePTFE film were layered together, and rolls were used to collapse the pores in the resulting assembly at a pressure of 2.4 kN/cm and temperature of 70° C. to yield a 50 μm-thick dense ePTFE (i.e., non-porous) film.

(3) Manufacture of Flat-Board Laminate

The aforementioned ePTFE film was wound and laminated onto a hollow stainless steel mandrel that had a diameter of 1,000 mm and length of 1,500 mm. After 110 windings, the end of the film was severed with a cutter, and double-sided adhesive tape was used to secure the severed end of the ePTFE film to the cylindrical laminate so as to prevent the film from unrolling. The aforementioned non-porous film was then wound once around the cylindrical film laminate, and the severed end was secured with double-sided adhesive tape. An ePTFE film was subsequently wound a further 110 times thereon, and the severed end was secured with double-sided adhesive tape.

The resulting cylindrical ePTFE film laminate, into which a non-porous layer had been inserted, was placed in an oven and sintered for 60 min at 365° C. Once the sintering was complete, the cylindrical laminate was removed from the oven and cooled to room temperature. The dimensions of the cylindrical laminate were approximately 1,000 mm (D₁)×1,020 mm (D₂)×1,500 mm (L₁), where D₁ is the inside diameter, D₂ is the outside diameter, and L₁ is the length in the axial direction.

After having cooled, the portions that had been secured with double-sided adhesive tape were cut open to yield a board laminate that was essentially flat, and that was approximately 1,500 mm (L₁)×3,000 mm (L₂)×10 mm (L₃).

(4) Manufacture of ePTFE Band

The aforementioned flat-board laminate was cut in the L₂ direction at 50 mm intervals along the L₁ direction to yield cut articles approximately 50 mm (L₁)×3,000 mm (L₂)×10 mm (L₃). Three of such articles were affixed together in the lamination (L₃) direction of the ePTFE films and thermocompression-bonded together to yield an article in the form of a rectangular column (used as Band 4 (made of ePTFE) hereunder) that was approximately 50 mm (L₁)×3,000 mm (L₂)×25 mm (L₃). The length L₃ was 25 mm and not 30 mm (i.e., 3×10 mm) because of the pressure applied in the compression bonding. The rectangular column was again cut in the L₂ direction in 4 mm intervals along the L₁ direction to yield Band 2 (with the direction of ePTFE film lamination being the width (W) direction; e.g., refer to FIG. 14), which had a height S1 of 4 mm (L₁), a length of 3,000 mm (L₂), and a width of 25 mm (L₃). Band 2 exhibited virtually no curling.

Band 3 (Made of Biaxially Expanded PTFE)

A band (i.e., tape) that had a height S1 of 6 mm, a length of 3,000 mm, and a width of 20 mm (with the direction of ePTFE film lamination being the width (W) direction; e.g., refer to FIG. 14) was obtained in the same manner as the aforementioned Band 2 (made of biaxially expanded PTFE), with the exception that the number of windings, slit width and other parameters were changed.

### Example 1

Band 1 (made of biaxially expanded PTFE; width: 25 mm×length: 3,000 mm×height S1: 4 mm; the direction of ePTFE film lamination was the height S1 direction, which was also the thickness (t) direction) was formed into a ring by means of being prefixed around the inner periphery and outer periphery of a metal ring that had an inside diameter of 270 mm, an outside diameter of 320 mm, and a thickness of 1 mm. Due to the excessive length of Band 1, an approximately 50 mm overlap was left when the band was formed into a ring, and the extraneous portion was cut off. When the band was prefixed into annular shape, a uniaxially expanded PTFE tape 10 mm wide and 0.1 mm thick was used to fasten the band to the metal ring so that the direction in which the aforementioned biaxially expanded PTFE was laminated (i.e., the height S1 direction) was made equal to the thickness (t) direction of the outer peripheral surface of the annular article. The article was heated in an oven at a temperature of 100° C. for one hour, and subsequently allowed to cool naturally to room temperature. The uniaxially expanded PTFE tape was released, and the temporary annular article made of biaxially expanded PTFE was separated from the metal ring. The inside diameter of the temporary annular article was approximately 290 to 295 mm, which was somewhat larger than the inside diameter during pre-fixing. On the other hand, the width remained 25 mm.

The ends of the aforementioned temporary annular article were brought together so that an inside diameter of 270 mm was obtained, after which the extraneous portion was cut off so that the amount by which the ends overlapped was 20 to 30 mm. A cut was made at an incline along the overlapping length, as shown in FIG. 1 (taper angle θ₁=10°). An adhesive (Front #107; Forefront Co.) was applied to the tapered surfaces, and the ends were joined to each other to yield a closed annular sealing material (with an inside diameter of 270 mm). The angle of elevation of the annular portion was approximately 10°.

### Example 2

A temporary annular article was manufactured in the same manner followed in the aforementioned Example 1, except that heating was performed at 200° C. for one hour. The inside diameter of the temporary annular article was 270 mm, and the pre-fixing dimensions were maintained. The width (W) decreased from 25 mm to approximately 23 mm due to thermal contraction.

The ends were joined to each other to form a closed annular sealing material (with an inside diameter of 270 mm) in the same manner as in Example 1. The angle of elevation of the annular portion was approximately 0°.

### Example 3

A temporary annular article was manufactured in the same manner as was followed in the aforementioned Example 1, except that heating was performed at 300° C. for one hour. The inside diameter of the temporary annular article was 270 mm, and the pre-fixing dimensions were maintained. The width (W) decreased from 25 mm to approximately 21 mm due to thermal contraction.

The ends were joined to each other to form a closed annular sealing material (with an inside diameter of 270 mm) in the same manner as in Example 1. The angle of elevation of the annular portion was approximately 0°.

### Example 4

A temporary annular article was manufactured in the same manner as followed in Experiment Example 1 except that Band 2 (made of biaxially expanded PTFE) was used (width: 25 mm×length: 1,000 mm×height S1: 4 mm; the direction of ePTFE film lamination was the width (W) direction). The ends were joined in the same manner as followed in Example 1 to yield a closed annular sealing material (having an inside diameter of 270 mm) in which the ePTFE films were laminated in the width (W) direction of the annular flat surface. The outward configurations of the temporary annular article and closed annular sealing material were the same as obtained in Experiment Example 1.

### Example 5

A temporary annular article was manufactured in the same manner as followed in Example 2 except that Band 2 (made of biaxially expanded PTFE) was used. The ends were joined in the same manner as followed in Example 2 to yield a closed annular sealing material (having an inside diameter of 270 mm) in which the ePTFE films were laminated in the width (W) direction of the annular flat surface. The inside diameter of the temporary annular article was 270 mm, and the pre-fixing dimensions were maintained. The width (W) remained 25 mm. The angle of elevation of the annular portion when the article was formed into a closed annular sealing material was approximately 0°.

### Example 6

A temporary annular article was manufactured in the same manner as followed in Example 3 except that Band 2 (made of biaxially expanded PTFE) was used. The ends were joined in the same manner as followed in Example 3 to yield a closed annular sealing material (having an inside diameter of 270 mm) in which the ePTFE films were laminated in the width (W) direction of the annular flat surface. The inside diameter of the temporary annular article was approximately 270 mm, and the pre-fixing dimensions were maintained. The width (W) decreased from 25 mm to 24 mm due to thermal contraction. The angle of elevation of the annular portion when the article was formed into a closed annular sealing material was approximately 0°.

As is evident from Examples 1 through 6, closed annular sealing materials may be manufactured regardless of the direction in which the ePTFE sheets have been laminated.

### Example 7

Band 3 (made of biaxially expanded PTFE; width: 20 mm×length: 3,000 mm×height S1: 6 mm; the direction of ePTFE film lamination was the width (W) direction) was prefixed into an elliptical shape whose length on the major axis (inside diameter) was 400 mm and whose length on the minor axis (inside diameter) was 300 mm, using punched metal (thickness: 2 mm) provided with holes that were three millimeters in diameter and were spaced at five-millimeter intervals. Due to the excessive length of Band 3, an approximately 50 mm overlap remained when the band was formed into a circle, and the extraneous portion was cut off. When the band was prefixed into an annular shape, a uniaxially expanded PTFE tape 10 mm wide and 0.1 mm thick was used to fasten the band to the punched metal so that the direction in which the aforementioned biaxially expanded PTFE was laminated was made equal to the width (W) direction of the annular flat surface of the annular article. The article was heated in an oven at a temperature of 150° C. for one hour, and subsequently allowed to cool naturally to room temperature. The uniaxially expanded PTFE tape was released, and the annular article made of the biaxially expanded PTFE was separated from the punched metal. The temporary annular article had retained an elliptical shape whose length on the major axis (inside diameter) was 400 mm and whose length on the minor axis (inside diameter) was 300 mm.

The ends were joined in the same manner as followed in Embodiment 1 to yield a closed annular sealing material (whose length on the major axis (inside diameter) was 400 mm and whose length on the minor axis (inside diameter) was 300 mm). The angle of elevation of the resulting annular portion was approximately 0°.

### Example 8

A model experiment was performed when Band 2 (made of biaxially expanded PTFE) was cut to a length of 300 mm, and a rectangular sealing material was produced. In other words, the experiment was performed in the same manner as followed in Example 7 except that the 300 mm-long band was prefixed to punched metal bent into an L-shape (i.e., a right angle). After heating, the aforementioned L-shaped portions (corner portions) had assumed a somewhat rounded shape but not a perfect corner, with the corner radii in the inner periphery being approximately 20 mm and the corner radii in the outer periphery being approximately 50 mm.

### Example 9

A temporary annular article was manufactured in the same manner followed in Example 4 except that heating was performed for approximately 10 mm with hot air blown from a heat gun (Sure Plajet; Ishizaki Electric Mfg. Co., Ltd.; nozzle temperature: 250° C.). The ends were joined to each other in the same manner followed in Experiment Example 4 to form a closed annular sealing material (inside diameter: 270 mm) in which the ePTFE films had been laminated in the width (W) direction of the annular flat surface.

The inside diameter of the temporary annular article was approximately 330 mm, which was larger than the diameter during prefixing. The angle of elevation of the annular portion of the closed annular sealing material was approximately 30 to 40°.

### Examples 10 and 11

Thick band 4 (made of biaxially expanded PTFE) that was obtained according to the description hereunder was used in the following Examples 10 and 11.

Band 4 (Made of Biaxially Expanded PTFE)

The article in the form of a rectangular column obtained during the process of manufacturing aforementioned Band 2 (made of biaxially expanded PTFE) was used as Band 4 (made of biaxially expanded PTFE). The dimensions of Band 4 (made of biaxially expanded PTFE) were: height S2=50 mm (L₁), length=3,000 mm (L₂), and width (W)=25 mm (L₃), with the direction of ePTFE film lamination being the width (W) direction (e.g., refer to FIG. 19).

### Example 10

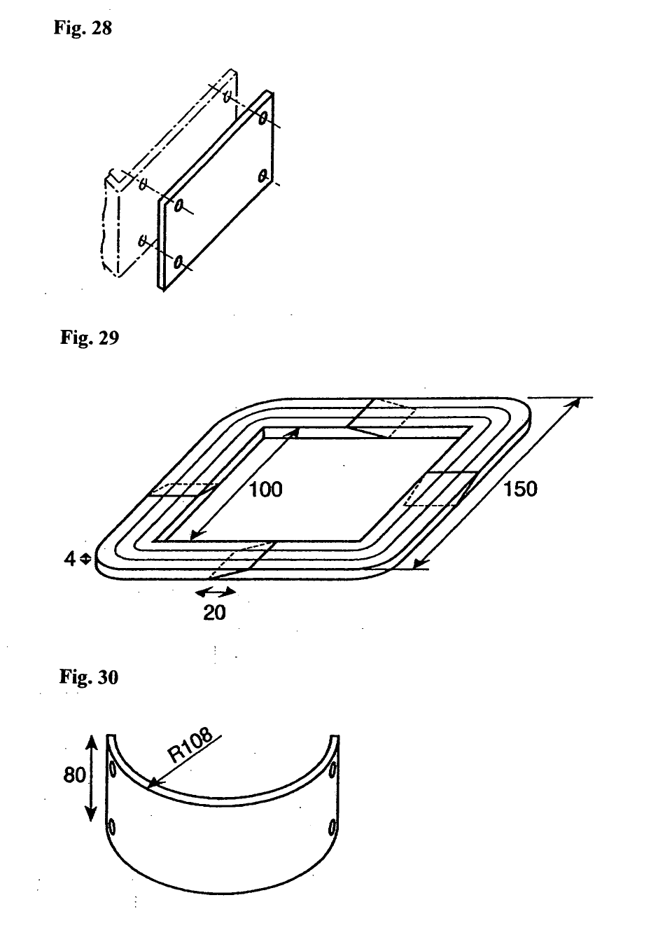

Band 4 (made of biaxially expanded PTFE) was cut to a length of approximately 300 mm, and preheated for approximately one hour in an oven at a temperature of 100° C. The band was prefixed (i.e., secured with bolts) as shown in FIG. 21(b), using the square support plate shown in FIG. 27 (with a bend angle of 65°) and the pressers shown in FIG. 28. The assembly was then thermoset for approximately one hour in an oven at a temperature of 150°, and subsequently allowed to cool naturally to room temperature. The support plate and pressers were removed to yield thick angled articles (i.e., parts) having a height of 50 mm, a length of 300 mm, and a width of 25 mm, with the direction of ePTFE film lamination being the width (W) direction (e.g., refer to FIG. 21(b)). The bend angle had increased to approximately 80°.

The aforementioned thick articles were sliced at 4 mm-high intervals to yield angled bands (i.e., parts) having a height of 4 mm, a length of 300 mm, and a width of 25 mm, with the direction of ePTFE film lamination being the width (W) direction. The bend angle had increased to approximately 90°, and the radii of the inscribed circles at the corners of the inner periphery of the bent portions were essentially 0 mm.

A total of four angled bands (i.e., parts) were produced, all of which were provided with tapered ends. The tapered surfaces were joined to each other using double-sided adhesive tape (#9458; Sumitomo 3M) to yield the rectangular closed annular sealing material shown in FIG. 29. The angle of elevation of the annular portion was 0°, and the radii of the inscribed circles at the corners of the inner periphery of the bent portions were essentially 0 mm.

### Example 11

Band 4 (made of biaxially expanded PTFE) was cut to a length of approximately 350 mm. The band was prefixed (i.e., secured with bolts) as shown in FIG. 21(a), using an arcuate support plate shown in FIG. 30 (with a radius of 108 mm) and the pressers shown in FIG. 31. The assembly was then thermoset for approximately one hour in an oven at a temperature of 150°, and subsequently allowed to cool naturally to room temperature. The support plate and pressers were removed to yield arcuate thick articles (i.e., parts) having a height of 50 mm, a length of 350 mm, and a width of 25 mm, with the direction of ePTFE film lamination being the width (W) direction. The radii of the arcuate thick articles were approximately 115 mm.

The aforementioned thick articles were sliced at 6 mm-high intervals to yield arcuate bands (i.e., parts) having a height of 6 mm, a length of 350 mm, and a width of 25 mm, with the direction of ePTFE film lamination being the width (W) direction), and with the radii of the arcuate thick articles having increased to approximately 135 mm.

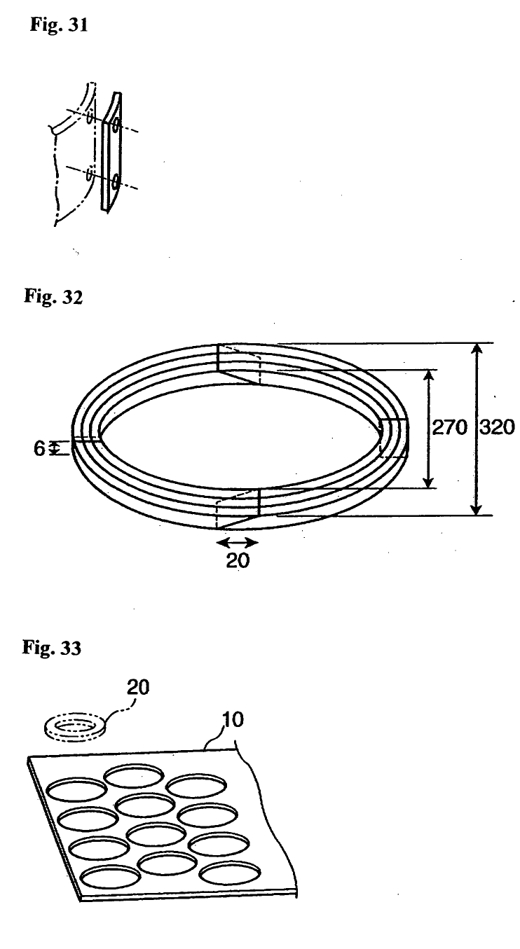

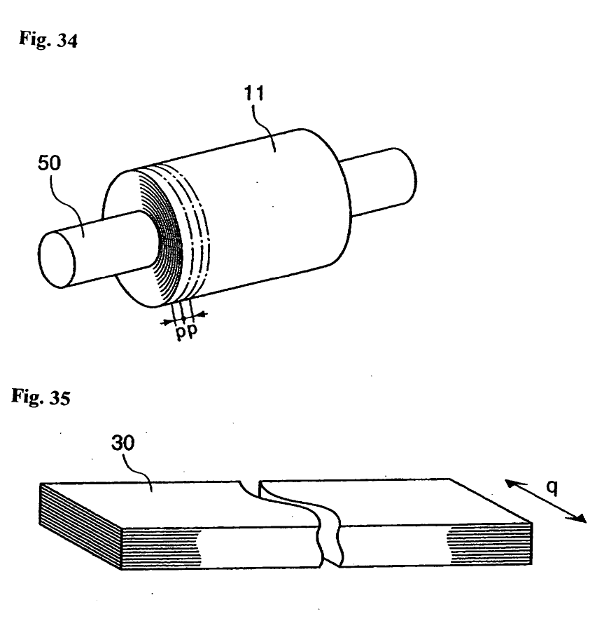

A total of four arcuate bands (i.e., parts) were produced, all of which were provided with tapered ends. The tapered surfaces were joined to each other using double-sided adhesive tape (#9458; Sumitomo 3M) to yield the round closed annular sealing material shown in FIG. 32. The angle of elevation of the annular portion was 0°.

### Comparative Example 1

Manufacture of Band 5 (Made of Biaxially Expanded PTFE

A sheet laminated from biaxially expanded PTFE films (thickness: 6 mm; sold commercially by Japan Gore-Tex, Inc. under the trade name “GoreTex Hyper-Sheet”) was cut to produce a band (i.e., a tape) that had a width of 25 mm, a length of 3,000 mm, and a height S1 of 6 mm (with the direction of ePTFE film lamination being the height (S1) direction, which is also the thickness (t) direction).

A 10-mm-wide double-sided adhesive tape (#9458; Sumitomo 3M) in which a release sheet was attached to one side thereof was affixed to one side surface (i.e., the length×width plane) of Band 5.

### Test Example 1

An evaluation was conducted on the usability and sealability of the round closed annular sealing material obtained in Example 11, and Band 5 obtained in Comparative Example 1.

Flange surfaces having a JIS 10K-250A-compliant flange size were separated, and the round closed annular sealing material of Example 11 was inserted thereinto. It was possible to insert the round closed annular sealing material easily and quickly.

Meanwhile, the same flange surfaces described in the foregoing were separated a considerable distance, and Band 5 of Comparative Example 1 was affixed thereto. A 20-mm-long taper was cut into the starting end of Band 5, and the band was affixed over the bearing surface of the seal on the flange surface as the release sheet was gradually peeled off from the starting end of the tape. The final end of the tape was laid over the tapered surface on the starting end of the tape, and once the starting and final ends had been connected, the tape was cut substantially horizontally, in the same manner illustrated in FIG. 26. When Band 5 was used, the flange surfaces had to be separated a considerable distance in order to provide sufficient space for the work to be carried out, and the tape had to be affixed along the bearing surface of the seal, which required a large amount of time.

Sealability

Flanges between which the round closed annular sealing material of Example 11 had been inserted as has been described in the foregoing, and a flange to which Band 5 of Comparative Example 1 had been affixed, were evaluated for sealability by means of measuring the amount of compressed air that leaked therefrom.

In other words, the flanges were tightened with bolts at a tightening torque of 120 N-m, whereupon compressed air was introduced via the pipes to which the flanges were connected. Once an internal pressure of 0.5 MPa had been attained, the compressed air feed line was shut off to yield a closed system. The change in the internal pressure over time once the system had been sealed was measured with a gauge, and the amount of leakage was calculated according to the formula below.

Amount of leakage=ΔP×A/T

(where T designates the time elapsed once the system had been sealed, ΔP the amount by which the internal pressure had decreased over time T, and A the volume of the sealed system)

The amount of leakage measured was less than 0.0001 Pa·m³/sec when the round closed annular sealing material of Example 11 was used, and also less than 0.0001 Pa·m³/sec when Band 5 of Comparative Example 1 was used.

As is evident from the results of the aforementioned tests, the closed annular sealing material of this invention can provide significantly improved usability without suffering any reduction in sealability.

The sealing material of this invention can maintain a substantially flat shape regardless of whether a band is used for the closed annular article, which enables the material to be handled in the same manner as punched or other common sealing materials. As a result, the effort required to install the sealing material on flanges or other areas that are to be sealed may be alleviated.

1. A closed annular sealing material, wherein:
the ends in the peripheral direction of one or a plurality of expanded porous polytetrafluoroethylene bands are joined to each other;
the width (W) of the sealing material from the inner periphery to the outer periphery is greater than the thickness (t) of the outer peripheral surface thereof; and
the angle of elevation of the annular portion of the sealing material in relation to the horizontal plane formed by the edge of the inner peripheral surface thereof is 0 to 45°.

2. A closed annular sealing material, wherein:
the ends in the peripheral direction of one or a plurality of expanded porous polytetrafluoroethylene bands are joined to each other;
the width (W) of the sealing material from the inner periphery to the outer periphery is greater than the thickness (t) of the outer peripheral surface thereof; and
the angle of elevation of the annular portion of the sealing material in relation to the horizontal plane formed by the edge of the inner peripheral surface thereof is 0°.

3. The closed annular sealing material according to claim 2, wherein the ratio (W/t) of width (W) and thickness (t) is 5 or greater.

4. The closed annular sealing material according to claim 2, wherein:
the closed annular sealing material is in a substantially annular shape; and
the ratio (x/W) of the diameter (x) of the inner periphery and width (W) is 15 or less.

5. The closed annular sealing material according to claim 3, wherein:
the closed annular sealing material is in a substantially annular shape; and
the ratio (x/W) of the diameter (x) of the inner periphery and width (W) is 15 or less

6 The closed annular sealing material according to claim 2, wherein:
the closed annular sealing material is in a rectangular shape; and
the radius of the inscribed circle at the corner of the inner periphery is 10 mm or less.

7. The closed annular sealing material according to claim 3, wherein:
the closed annular sealing material is in a rectangular shape; and
the radius of the inscribed circle at the corner of the inner periphery is 10 mm or less.

8. The closed annular sealing material according to claim 2, wherein:
the closed annular sealing material is in a rectangular shape; and
the radius of the inscribed circle at the corner of the inner periphery is 0 mm.

9. The closed annular sealing material according to claim 3, wherein:
the closed annular sealing material is in a rectangular shape; and
the radius of the inscribed circle at the corner of the inner periphery is 0 mm.

10. The closed annular sealing material according to claim 1, wherein the annular portion has a laminate structure of expanded porous polytetrafluoroethylene layers.

11. The closed annular sealing material according to claim 2, wherein the annular portion has a laminate structure of expanded porous polytetrafluoroethylene layers.

12. The closed annular sealing material according to claim 3, wherein the annular portion has a laminate structure of expanded porous polytetrafluoroethylene layers.

13. The closed annular sealing material according to claim 10, wherein the expanded porous polytetrafluoroethylene layers are laminated in the width (W) direction.

14. The closed annular sealing material according to claim 13, wherein the annular portion comprises a nonporous polytetrafluoroethylene layer inserted between the laminated expanded porous polytetrafluoroethylene layers.

15. The closed annular sealing material according to claim 10, wherein the expanded porous polytetrafluoroethylene layers are laminated in the thickness (t) direction.

16. The closed annular sealing material according to claim 1, wherein in which at least one end of the band in the peripheral direction is tapered; and the tapered surface comprises at least part of the band joint.

17. The closed annular sealing material according to claims 2, wherein in which at least one end of the band in the peripheral direction is tapered; and the tapered surface comprises at least part of the band joint.

18. The closed annular sealing material according to claim 3, wherein in which at least one end of the band in the peripheral direction is tapered; and the tapered surface comprises at least part of the band joint.

19. The closed annular sealing material according to claim 1, wherein the two ends of the band are joined by at least one means selected from double-sided adhesive tape, (adhesive, and heat fusion or ultrasonic welding via at least one film selected from a group consisting of a tetrafluoroethylene-hexafluoropropylene copolymerized film and a tetrafluoroethylene-perfluoroalkylvinylether copolymerized film.

20. The closed annular sealing material according to claim 2, wherein the two ends of the band are joined by at least one means selected from double-sided adhesive tape, adhesive, and heat fusion or ultrasonic welding via at least one film selected from a group consisting of a tetrafluoroethylene-hexafluoropropylene copolymerized film and a tetrafluoroethylene-perfluoroalkylvinylether copolymerized film.

21. The closed annular sealing material according to claim 3, wherein the two ends of the band are joined by at least one means selected from:
double-sided adhesive tape,
adhesive, and
heat fusion or ultrasonic welding via at least one film selected from a group consisting of a tetrafluoroethylene-hexafluoropropylene copolymerized film and a tetrafluoroethylene-perfluoroalkylvinylether copolymerized film.

22. A closed annular sealing material according to claim 1, wherein an adhesive layer is formed on either one of the annular flat surfaces orthogonal to the outer peripheral surface.

23. A closed annular sealing material according to claim 2, wherein an adhesive layer is formed on either one of the annular flat surfaces orthogonal to the outer peripheral surface.

24. A closed annular sealing material according to claim 3, wherein an adhesive layer is formed on either one of the annular flat surfaces orthogonal to the outer peripheral surface.

25. A method for manufacturing the closed annular sealing material according to claim 1, comprising:
bending in the width (W) direction one or a plurality of expanded porous polytetrafluoroethylene bands whose length in the thickness (t) direction of the resulting closed annular sealing material is less than the width (W) thereof to form a ring as a whole;
pre-fixing the bands to maintain the bent shape;
thermosetting the bands; and
joining the two ends in the peripheral direction of the bands with each other before, during, or after the thermosetting,
where the directions are defined based in a coordinate system comprising the width (W) direction, thickness (t) direction, and peripheral direction of the resulting closed annular sealing material.

26 A method for manufacturing the closed annular sealing material according to claim 2, comprising:
bending in the width (W) direction one or a plurality of expanded porous polytetrafluoroethylene bands and/or boards whose length in the thickness (t) direction of the resulting closed annular sealing material is equal to or greater than the width (W) thereof to form a ring as a whole;
pre-fixing the bands and/or boards to maintain the bent shape;
thermosetting the bands and/or boards;
slicing the resulting thermoset assembly to a prescribed thickness (t); and
joining the two ends in the peripheral direction of the thick bands, thick boards, or slices thereof with each other before, during, or after the thermosetting,
where the directions are defined based in a coordinate system comprising the width (W) direction, thickness (t) direction, and peripheral direction of the resulting closed annular sealing material.

27. The method for manufacturing a closed annular sealing material according to claim 26, wherein the joining is performed after the slicing.
